(19) United States
(12) Patent Application Publication
(10) Pub. No.: US 2026/0246612 A1
(43) Pub. Date: Aug. 20, 2026

(54) BLOCKCHAIN TRANSACTION DATA MANAGEMENT SYSTEM AND METHOD FOR MANAGING BLOCKCHAIN BASED TRANSACTION DATA USING HYBRID CRYPTOGRAPHIC TECHNIQUES

(71) Applicant: Web3Firewall, Inc., San Francisco, CA (US)

(72) Inventor: Samer N. Fayssal, Mountain House, CA (US)

(21) Appl. No.: 19/272,240

(22) Filed: Jul. 17, 2025

Related U.S. Application Data
(60) Provisional application No. 63/760,450, filed on Feb. 19, 2025.

(51) Int. Cl. H04L 9/06; H04L 9/00; H04L 9/40

(52) U.S. Cl. CPC H04L 9/0643; H04L 9/008; H04L 9/50; H04L 63/1433

(57) ABSTRACT

A blockchain transaction data management method and system for managing blockchain based transaction data is disclosed. The blockchain transaction data management method includes: obtaining the blockchain based transaction data in form of plain text data from communication devices; classifying blockchain based transaction data as sensitive computational transaction data and reference transaction data; encrypting the sensitive computational transaction data when the blockchain based transaction data are classified as the sensitive computational transaction data, using a FHE technique; hashing the reference transaction data for validating blockchain transactions when the blockchain based transaction data are classified as reference transaction data, using cryptographic hashing techniques; performing computation-based operations on the encrypted sensitive computational transaction data to generate preserved encrypted and hashed text data without accessing the plain text data; and providing the generated preserved plain text data associated with the blockchain based transaction data, as output, to the communication devices of users.

### CROSS REFERENCE TO RELATED APPLICATION(S)

This application claims the priority to and incorporates by reference the entire disclosure of U.S. provisional patent application bearing No. 63/760,450 filed on Feb. 19, 2025.

### TECHNICAL FIELD

Embodiments of the present disclosure relates to a hybrid data security gateway and more particularly relates to a blockchain transaction data management system and method for blockchain transaction data management using hybrid cryptographic techniques including Fully Homomorphic Encryption (FHE) and cryptographic hashing techniques.

### BACKGROUND

Blockchain technology has revolutionized the way transactions are conducted and verified by providing a decentralized, tamper-resistant ledger. Blockchain technology ensures transparency and security through cryptographic mechanisms, making blockchain technology widely adopted in financial transactions, supply chain management, identity verification, and other domains requiring trustless interactions. However, ensuring the privacy and security of transaction data while maintaining computational efficiency remains a significant challenge.

A key issue in blockchain risk systems is the need to process and verify transactions while protecting sensitive data from unauthorized users. Conventional systems rely on cryptographic techniques such as Fully Homomorphic Encryption (FHE) and cryptographic hashing to address this issue. The FHE and the cryptographic hashing, when used separately, present significant trade-offs.

The FHE enables computations to be performed directly on encrypted data, preserving confidentiality throughout the process. This makes the FHE a valuable tool for privacy-preserving blockchain applications. However, FHE-based solutions impose substantial computational overhead due to the complexity of performing operations on encrypted data. This results in high latency and processing inefficiencies, making it impossible for real-time applications, high-throughput blockchains, or resource-constrained environments to maximize benefits.

On the other hand, the cryptographic hashing is widely used in blockchain systems to ensure data integrity, secure transaction verification, and maintain lightweight structures such as Merkle trees for efficient validation, and the like. Hashing provides computational efficiency but lacks the ability to perform secure computations on hashed data. Once data is hashed, the hashed data becomes a fixed reference that cannot be used for further cryptographic operations or transformations without first revealing the original plain text. This limitation reduces the flexibility of hashed data in applications that require both privacy and efficient computational processing.

Existing blockchain security mechanisms often adopt at least one of: encryption-based approaches that hinder efficiency or hashing-based approaches that do not support secure computation. Current systems seek to either encrypt the shared data and face scalability issues or share the data in plain text and risk disclosing sensitive information. To protect the shared pre-broadcast data in encrypted form, the given systems suffer from scalability issues in large-scale blockchain networks.

Additionally, conventional blockchain systems face challenges related to data storage, retrieval, and synchronization when dealing with at least one of: encrypted transaction data or hashed transaction data. Managing encrypted transaction data without exposing sensitive information while maintaining accessibility for computations remains a persistent challenge. The trade-offs between privacy, efficiency, and computational viability limit the effectiveness of conventional blockchain transaction management security models.

Thus, there remains a need for a blockchain transaction data management system and method with a hybrid cryptographic platform that preserves privacy, ensures data integrity, and allows efficient computations on the encrypted transaction data and the hashed transaction data, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a blockchain transaction data management method for managing blockchain based transaction data using hybrid cryptographic techniques, is disclosed. The blockchain transaction data management method comprises obtaining, by one or more hardware processors, the blockchain based transaction data in a form of plain text data from one or more communication devices associated with one or more users.

The blockchain transaction data management method further comprises classifying, by the one or more hardware processors, the blockchain based transaction data as at least one of: sensitive computational transaction data and reference transaction data. The blockchain transaction data management method further comprises performing, by the one or more hardware processors, one or more operations comprising at least one of: (a) encrypting, by the one or more hardware processors, the sensitive computational transaction data when the blockchain based transaction data are classified as the sensitive computational transaction data, using a Fully Homomorphic Encryption (FHE) technique; and (b) hashing, by the one or more hardware processors, the reference transaction data for validating blockchain transactions when the blockchain based transaction data are classified as the reference transaction data, using one or more cryptographic hashing techniques.

The blockchain transaction data management method further comprises performing, by the one or more hardware processors, one or more computation-based operations on the encrypted sensitive computational transaction data during validation of the blockchain transactions by the hashed reference transaction data, to generate preserved encrypted and hashed text data without accessing the plain text data. The blockchain transaction data management method further comprises performing, by the one or more hardware processors, at least one of: storing, synchronizing, and retrieving, the preserved encrypted and hashed text data associated with the blockchain based transaction data, within a blockchain system. The blockchain transaction data management method further comprises providing, by the one or more hardware processors, the generated preserved plain text data associated with the blockchain based transaction data, as output, to the one or more user interfaces associated with the one or more communication devices of the one or more users.

In an embodiment, the blockchain transaction data management method further comprises: (a) assessing, by the one or more hardware processors, security and risk level of the blockchain based transaction data based on one or more pre-defined security parameters; (b) generating, by the one or more hardware processors, one or more risk scores for the blockchain based transaction data based on the security and risk level of the blockchain based transaction data; and (c) performing, by the one or more hardware processors, one or more further operations comprising at least one of: encrypting and hashing the blockchain based transaction data based on the one or more risk scores generated for the blockchain based transaction data, to optimize security.

In another embodiment, the blockchain transaction data management method further comprises: (a) analyzing, by the one or more hardware processors, at least one of: a structure and requirements of one or more application programming interfaces (APIs) within a blockchain transaction data management system; and (b) selecting, by the one or more hardware processors, one or more corresponding APIs based on at least one of: a nature of one or more services required and a type of date retrieval needed for blockchain based transaction data management.

In yet another embodiment, the blockchain based transaction data comprise at least one of: transaction identities, sender and recipient details, amounts, timestamps, transaction signatures, reference metadata, transaction fees, block numbers, and consensus-related information.

In yet another embodiment, the sensitive computational transaction data comprise at least one of: user identities, private financial details, and confidential contract terms, which are encrypted using the Fully Homomorphic Encryption (FHE) technique.

In yet another embodiment, the reference transaction data comprise at least one of: public cryptocurrency addresses, transaction identifiers, and verifiable records, which are hashed using the cryptographic hashing techniques, wherein the cryptographic hashing techniques comprise secure hash algorithm with 256-bit fixed-length hash (SHA-256).

In one aspect, a blockchain transaction data management system for managing blockchain based transaction data using hybrid cryptographic techniques, is disclosed. The blockchain transaction data management system comprises one or more hardware processors an da memory. The memory is coupled to the one or more hardware processors. The memory comprises a plurality of subsystems in form of programmable instructions executable by the one or more hardware processors.

The plurality of subsystems comprises a data obtaining subsystem configured to obtain the blockchain based transaction data in a form of plain text data from one or more communication devices associated with one or more users. The plurality of subsystems further comprises a data classification subsystem configured to classify the blockchain based transaction data as at least one of: sensitive computational transaction data and reference transaction data. The plurality of subsystems further comprises a data encryption subsystem configured to encrypt the sensitive computational transaction data when the blockchain based transaction data are classified as the sensitive computational transaction data, by a FHE subsystem using a Fully Homomorphic Encryption (FHE) technique.

The data encryption subsystem is further configured to hash the reference transaction data for validating blockchain transactions when the blockchain based transaction data are classified as the reference transaction data, by a hashing subsystem using one or more cryptographic hashing techniques. The plurality of subsystems further comprises a data computation subsystem configured to perform one or more computation-based operations on the encrypted sensitive computational transaction data during validation of the blockchain transactions by the hashed reference transaction data, to generate preserved encrypted and hashed text data without accessing the plain text data.

The plurality of subsystems further comprises a data management subsystem configured to perform at least one of: storing, synchronizing, and retrieving, the preserved encrypted and hashed text data associated with the blockchain based transaction data, within a blockchain system. The plurality of subsystems further comprises a data output subsystem configured to provide the generated preserved plain text data associated with the blockchain based transaction data, as output, to the one or more user interfaces associated with the one or more communication devices of the one or more users.

In another aspect, a non-transitory computer-readable storage medium having instructions stored therein that, when executed by the one or more hardware processors, causes the one or more hardware processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram representation of a network architecture of a hybrid data security gateway, in accordance with an embodiment of the present disclosure;

FIG. 2 illustrates an exemplary block diagram representation of a blockchain transaction data management system as shown in FIG. 1 implementing the hybrid data security gateway, in accordance with an embodiment of the present disclosure;

FIG. 3 illustrates an exemplary block diagram of the blockchain transaction data management system comprising a data encryption subsystem, in accordance with an embodiment of the present disclosure;

FIG. 4 illustrates an exemplary block diagram of the blockchain transaction data management system comprising the data encryption subsystem to process and manage Bitcoin based transaction data, in accordance with an embodiment of the present disclosure;

FIG. 5 illustrates an exemplary block diagram of the data encryption subsystem comprising a risk processor, in accordance with an embodiment of the present disclosure;

FIG. 6A illustrates an exemplary block diagram of the data encryption subsystem comprising a hash processor, in accordance with an embodiment of the present disclosure;

FIG. 6B illustrates an exemplary block diagram of a hashing subsystem, in accordance with an embodiment of the present disclosure; and

FIG. 7 is a flow diagram illustrating a blockchain transaction data management method for managing blockchain based transaction data using hybrid cryptographic techniques, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises... a“ does not, without more constraints, preclude the existence of other devices, sub-systems, additional sub-modules. Appearances of the phrase ”in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

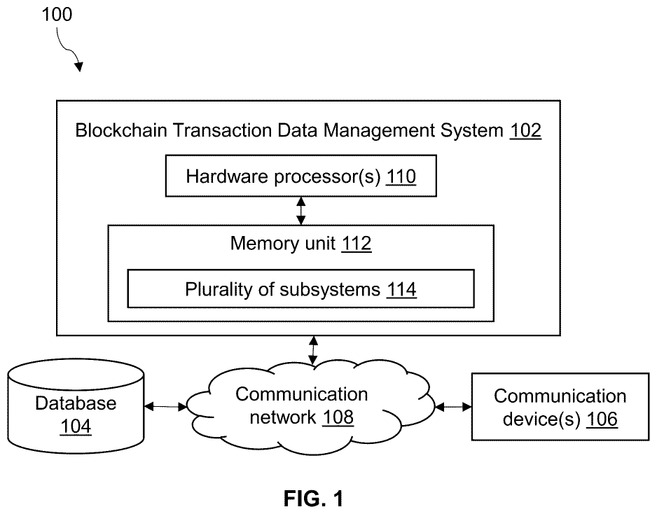

Referring now to the drawings, and more particularly to FIGS. 1 through 7, where similar reference characters denote corresponding features consistently throughout the figures, there are shown preferred embodiments, and these embodiments are described in the context of the following exemplary system and/or method.

FIG. 1 illustrates an exemplary block diagram representation of a hybrid data security gateway 100 of blockchain transaction data management system 102 for protecting the privacy and security of blockchain based transaction data, in accordance with an embodiment of the present disclosure.

According to an exemplary embodiment of the present disclosure, FIG. 1 depicts the hybrid data security gateway 100 that may include the blockchain transaction data management system 102, a database 104, and the one or more communication devices 106. In an embodiment, the blockchain transaction data management system 102 and a system 102 may be used interchangeably throughout the description. The system 102 may be communicatively coupled to the database 104, and the one or more communication devices 106 via a communication network 108. The communication network 108 may be a wired communication network and/or a wireless communication network. The database 104 may include, but not limited to, storing, managing, and organizing diverse data pertinent to blockchain based transaction data received from the one or more communication devices 106. The database 104 may also store information about specifications of the one or more blockchain transactions, user profiles, historical data related to blockchain transactions, service records, transaction patterns, and the like.

In an exemplary embodiment, the communication network 108 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fiber optic network, a satellite network, a cloud computing network, a combination of networks, and the like. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including fourth generation (4G) technologies and fifth generation (5G) technologies), Bluetooth®, ZigBee®, long-range wide area network (LoRaWAN), satellite communication, radio frequency identification (RFID), 6G (sixth generation) networks, advanced IoT protocols, mesh networks, non-terrestrial networks (NTNs), near field communication (NFC), and the like.

The database 104 may be any kind of database such as, but not limited to, relational databases, non-relational databases, graph databases, document databases, dedicated databases, dynamic databases, monetized databases, scalable databases, cloud databases, distributed databases, any other databases, and a combination thereof. The database 104 is configured to support the functionality of the system 102 and enable efficient data retrieval and storage for various aspects associated with the blockchain transaction data management.

In an exemplary embodiment, the one or more communication devices 106 may include, but not limited to, a mobile device, a smartphone, a Personal Digital Assistant (PDA), a tablet computer, a phablet computer, a laptop, and the like. The one or more communication devices 106 also serve a user interface for the data output subsystem 222 through which one or more users interact with the system 102 for blockchain transaction data management. The one or more communication devices 106 is configured to enable the one or more users to access and interact with the system 102 from various locations and contexts, facilitating remote collaboration, real-time updates, and on-the-go decision-making for the blockchain transaction data management. In an exemplary embodiment, the one or more communication devices 106 may also include cellularly enabled devices and Wireless Fidelity (Wi-Fi) enabled devices. Each of the one or more users is also referred to as a hybrid security gateway user 302.

In an exemplary embodiment, the one or more communication devices 106 may be associated with, but not limited to, one or more service providers, one or more customers, an individual, an administrator, a vendor, a technician, a worker, a specialist, an instructor, a supervisor, a team, an entity, an organization, a company, a facility, a bot, the one or more users, and combination thereof.

The system 102 is initially configured to obtain the blockchain based transaction data in a form of plain text data from one or more communication devices 106 associated with one or more users (i.e., the hybrid security gateway user 302). The system 102 is further configured to classify the blockchain based transaction data as at least one of: sensitive computational transaction data and reference transaction data. The system 102 is further configured to encrypt the sensitive computational transaction data when the blockchain based transaction data are classified as the sensitive computational transaction data, using a Fully Homomorphic Encryption (FHE) technique.

The system 102 is further configured to hash the reference transaction data for validating blockchain transactions when the blockchain based transaction data are classified as the reference transaction data, using one or more cryptographic hashing techniques. The system 102 is further configured to perform one or more computation-based operations on the encrypted sensitive computational transaction data during validation of the blockchain transactions by the hashed reference transaction data, to generate preserved encrypted and hashed text data without accessing the plain text data.

The system 102 is further configured to perform at least one of: storing, synchronizing, and retrieving, the preserved encrypted and hashed text data associated with the blockchain based transaction data, within a blockchain system. The system 102 is further configured to provide the generated preserved plain text data associated with the blockchain based transaction data, as output, to the one or more user interfaces associated with the one or more communication devices 106 of the one or more users.

The hybrid data security gateway 100 facilitates seamless processing and management of the blockchain based transaction data. The hybrid data security gateway 100 provides a scalable and secure solution for blockchain transaction data management by combining the strengths of the Fully Homomorphic Encryption (FHE) and the cryptographic hashing techniques. The hybrid data security gateway 100 comprising the system 102 ensures privacy, reduces computational overhead, and enhances the overall efficiency of blockchain systems. The capability of the system 102 for blockchain transaction data management is underpinned by effective collaboration among the system 102, the database 104, and the one or more communication devices 106 within the communication network 108.

Further, the system 102 may be implemented by way of a single device or a combination of multiple devices that may be operatively connected or networked together. The system 102 may be implemented with hardware or a suitable combination of hardware and software. The system 102 includes one or more hardware processors 110 and a memory unit 112. The memory unit 112 may include a plurality of subsystems 114. The system 102 may be the one or more hardware processors 110 executing machine-readable program instructions for determining the one or more operational parameters of the one or more communication devices 106. Execution of the machine-readable program instructions by the one or more hardware processors 110 may enable the system 102 to dynamically process and manage the blockchain based transaction data.

The course of action sequences may involve various steps or decisions taken for data-receiving, data processing, data management calling one or more Application Programming Interfaces (APIs) through the API gateway subsystem 208, data classification, data encryption, data computation, data management, and the like. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, the one or more hardware processors 110 may fetch and execute computer-readable instructions in the memory unit 112 operationally coupled with the system 102 for performing tasks such as data processing, input/output processing, and/or any other functions. Any reference to a task in the present disclosure may refer to an operation being or that may be performed on data.

Though a few components and subsystems are disclosed in FIG. 1, there may be additional components and subsystems which is not shown, such as, but not limited to, ports, routers, repeaters, firewall devices, network devices, databases, network attached storage devices, servers, assets, emergency management devices, any other devices, and combination thereof. A person skilled in the art should not be limiting the components/subsystems shown in FIG. 1.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

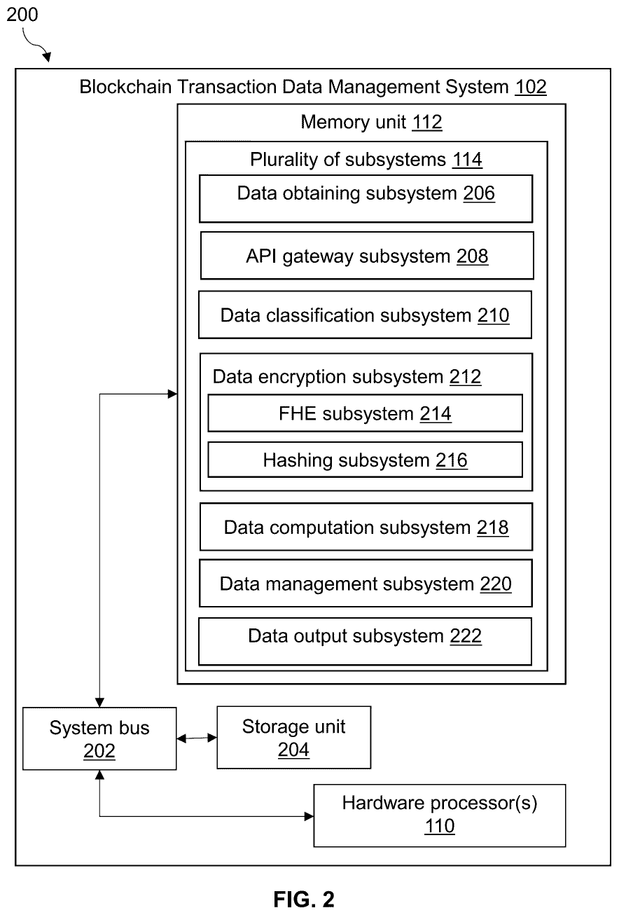

FIG. 2 illustrates an exemplary block diagram 200 representation of the blockchain transaction data management system 102 as shown in FIG. 1 implementing the hybrid data security gateway 100, in accordance with an embodiment of the present disclosure.

In an exemplary embodiment, the system 102 or the Blockchain transaction data management system 102 comprises the one or more hardware processors 110, the memory unit 112, and a storage unit 204. The one or more hardware processors 110, the memory unit 112, and the storage unit 204 are communicatively coupled through a system bus 202 or any similar mechanism. The memory unit 112 is operatively coupled to the one or more hardware processors 110. The memory unit 112 comprises the plurality of subsystems 114 in the form of programmable instructions executable by the one or more hardware processors 110.

In an exemplary embodiment, the plurality of subsystems 114 comprises a data-obtaining subsystem 206, an Application Programming Interface (API) gateway subsystem 208, a data classification subsystem 210, a data encryption subsystem 212, a data computation subsystem 218, a data management subsystem 220, and a data output subsystem 222. The data encryption subsystem 212 further comprises a Fully Homomorphic Encryption (FHE) subsystem 214 and a hashing subsystem 216.

The one or more hardware processors 110, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory unit 112 may be a non-transitory volatile memory and a non-volatile memory. The memory unit 112 may be coupled to communicate with the one or more hardware processors 110, such as being a computer-readable storage medium. The one or more hardware processors 110 may execute machine-readable instructions and/or source code stored in the memory unit 112. A variety of machine-readable instructions may be stored in and accessed from the memory unit 112.

The memory unit 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 112 includes the plurality of subsystems 114 stored in the form of machine-readable instructions on any of the above-mentioned storage media and may be in communication with and executed by the one or more hardware processors 110.

The storage unit 204 may be a cloud storage or the database 104 such as those shown in FIG. 1. The storage unit 204 in the system 102 is responsible for securely managing various types of data related to blockchain transactions. This includes encrypted sensitive data, such as user identities and private financial details, which are protected using Fully Homomorphic Encryption (FHE). The storage unit 204 also stores hashed reference data, such as cryptocurrency addresses and public keys, ensuring efficient verification and integrity. Additionally, the storage unit 204 manages processed data, including the results of computations performed on encrypted data, as well as transaction metadata such as timestamps, transaction IDs, and the like. The storage unit 204 also holds blockchain-specific data such as block headers and proofs of validity, alongside synchronization information for maintaining consistency across multiple block chain nodes. Further, the storage unit 204 may store audit logs, verification data, public key infrastructure (PKI) data, and the like, to support traceability, system integrity, and security. All these data types work together to ensure the privacy, integrity, and efficiency of blockchain transactions within the system 102. The storage unit 204 may be any kind of the database 104 such as, but not limited to, relational databases, dedicated databases, dynamic databases, monetized databases, scalable databases, cloud databases, distributed databases, and a combination thereof.

The system 102 provides a scalable and secure solution for blockchain transaction data management by combining the strengths of Fully Homomorphic Encryption and cryptographic hashing. This hybrid data security gateway ensures privacy, reduces computational overhead, and enhances the overall efficiency of the blockchain systems.

The data obtaining subsystem 206 is configured to obtain the Blockchain based transaction data and relevant transaction metadata from the one or more users of various blockchain platforms, including Bitcoin, Ethereum, and similar decentralized networks. The data obtaining subsystem 206 is configured to receive sensitive computational transaction data, such as transaction IDs, sender and recipient details, amounts, timestamps, and transaction signatures, additional reference metadata, transaction fees, block numbers, consensus-related information, and the like. By receiving diverse types of data, the data obtaining subsystem 206 ensures that all relevant blockchain transaction information is collected for subsequent handling and processing.

In an exemplary embodiment, the API gateway subsystem 208 is configured to analyze a structure and requirements of the diverse one or more APIs within the system 102. The API gateway subsystem 208 selects the one or more appropriate APIs based on the nature of the one or more services required and the type of data retrieval needed regarding the blockchain transaction data management.

The data classification subsystem 210 is configured to determine whether the received blockchain based transaction data is at least one of: sensitive computational transaction data and reference transaction data. The sensitive computational transaction data is data sensitive with processable value. The reference transaction data does not require computation and is data sensitive with reference values. The sensitive computational transaction data includes transaction values, transaction fees, and the like. The reference values includes source addresses, destination addresses and the like.

The data encryption subsystem 212 is configured to at least one of: encrypt data and hash data based on the classification of the received blockchain transaction data. Further, the data encryption subsystem 212 comprise, the FHE subsystem 214 and the hashing subsystem 216. The FHE subsystem 214 is configured to encrypt the sensitive computational transaction data using the Fully Homomorphic Encryption (FHE) technique to enable secure computations. The hashing subsystem 216 is further configured to hash the classified reference transaction data using the cryptographic hashing techniques such as SHA-256, and the like.

The FHE subsystem 214 is configured to utilize the Fully Homomorphic Encryption (FHE) to encrypt the sensitive computational transaction data, such as user identities, private financial details, confidential contract terms, and the like. The FHE subsystem 214 is configured to enable computations to be performed directly on the encrypted sensitive computational transaction data without requiring decryption of the sensitive computational transaction data, thereby preserving privacy. The FHE subsystem 214 is configured to ensure the secure execution of complex computations without exposing the received user data as plaintext.

Further, the hashing subsystem 216 is configured to utilize the cryptographic hashing techniques (herein referred to as hashing) for the reference transaction data (i.e., data that does not require computation), including public cryptocurrency addresses, transaction identifiers, other verifiable records, and the like. The cryptographic hashing techniques may include SHA-256, and the like. The cryptographic hashing techniques used over the reference transaction data ensure efficient storage, quick lookups, and verification while maintaining data integrity and immutability. Unlike the encrypted data, hashed data remains lightweight and computationally efficient, making it suitable for integrity verification and transaction validation.

The data computation subsystem 218 is configured to perform one or more computation-based operations on the encrypted sensitive computational transaction data during validation of the blockchain transactions by the hashed reference transaction data, to generate preserved encrypted and hashed text data without accessing the plain text data.

The data management subsystem 220 is configured to handle storage, synchronize, and retrieve encrypted sensitive computational transaction data and hashed reference transaction data. The data management subsystem 220 handles storage, synchronizes, and retrieves the encrypted sensitive computational transaction data and the hashed reference transaction data without having access to plaintext data thereby ensuring synchronization, privacy and integrity.

The data output subsystem 222 is configured to output on the Graphical user interface of the one or more users privacy preserved text pertinent to the blockchain transaction stored in the database 104. In other words, the data output subsystem 222 is configured to provide the generated preserved plain text data associated with the blockchain based transaction data, as output, to the one or more user interfaces associated with the one or more communication devices 106 of the one or more users.

The method for blockchain transaction data management comprises the following steps. In the first step, the blockchain based transaction data is classified into the sensitive computational transaction data and the reference transaction data. In the second step, the sensitive computational transaction data is encrypted using the Fully Homomorphic Encryption (FHE) technique to preserve privacy during computations. In the third step, the reference sensitive computational transaction data is hashed for efficient storage and verification. In the fourth step, the one or more computations are performed on the encrypted data using homomorphic techniques, ensuring secure processing without decryption. Finally, In the fifth step, the sensitive computational transaction data is stored and managed within the blockchain system, maintaining its integrity and confidentiality throughout the transaction lifecycle. In another embodiment the method for blockchain transaction data management additionally comprises verifying the integrity of hashed data during blockchain synchronization.

In an exemplary embodiment of the present disclosure, the reference transaction data does not require computations and includes cryptocurrency addresses, public keys, and the like.

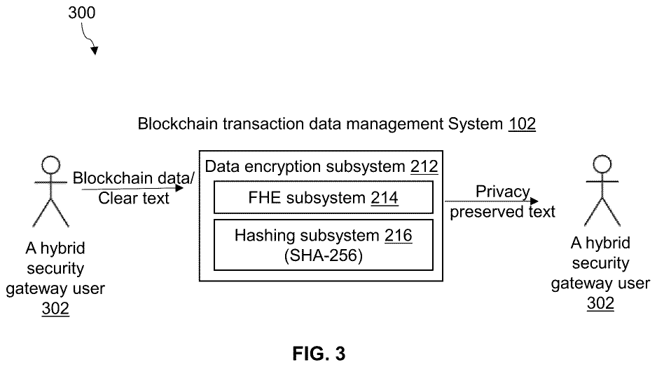

FIG. 3 illustrates an exemplary block diagram 300 of the blockchain transaction data management system 102 comprising the data encryption subsystem 212, in accordance with an embodiment of the present disclosure. Each of the one or more users, referred to as the hybrid security gateway user 302, provides blockchain based transaction data as clear, readable text to the blockchain transaction data management system 102. The blockchain transaction data management system 102 comprises the data encryption subsystem 212, which is configured to receive classified transaction data from the data classification subsystem 210. The data encryption subsystem 212 further includes the FHE subsystem 214 and the hashing subsystem 216. The FHE subsystem 214 is configured to encrypt the classified sensitive computational transaction data from the received blockchain based transaction data using the Fully Homomorphic Encryption (FHE) technique, ensuring privacy-preserving computations.

The hashing subsystem 216 is further configured to apply the cryptographic hashing techniques, such as SHA-256, to the reference transaction data, including public cryptocurrency addresses, transaction identifiers, and other verifiable records, ensuring efficient storage and integrity verification. By utilizing FHE encryption and cryptographic hashing, the originally provided clear, readable text is transformed into privacy-preserved encrypted and hashed text. The privacy-preserved text can be validated, stored, retrieved, and used by the hybrid security gateway user 302 at any point in time while maintaining the confidentiality and integrity of the blockchain transaction data.

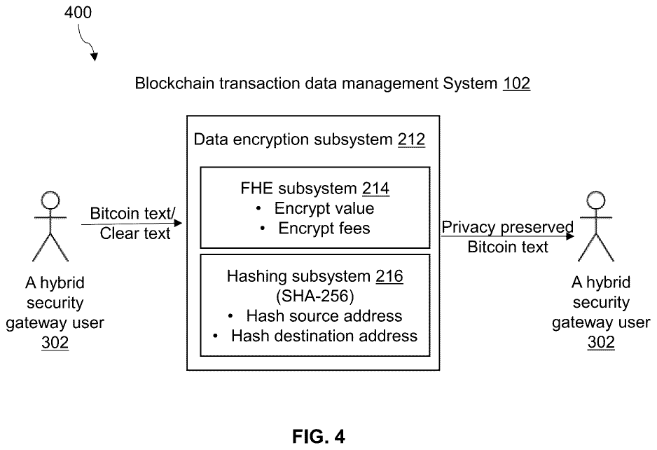

FIG. 4 illustrates an exemplary block diagram 400 of the blockchain transaction data management system 102 comprising the data encryption subsystem 212 to process and manage Bitcoin based transaction data, in accordance with an embodiment of the present disclosure. Each of the one or more users, referred to as the hybrid security gateway user 302, provides Bitcoin transaction data or Bitcoin text as clear, readable text to the blockchain transaction data management system 102. The blockchain transaction data management system 102 comprises the data encryption subsystem 212, which is configured to receive classified transaction data from the data classification subsystem 210. The data encryption subsystem 212 further includes the FHE subsystem 214 and the hashing subsystem 216. The FHE subsystem 214 is configured to encrypt the classified sensitive computational transaction data from the received blockchain transaction data using the Fully Homomorphic Encryption (FHE) technique, ensuring privacy-preserving computations. Encrypting the classified sensitive computational transaction data includes encrypting transaction values, encrypting transaction fees, and the like.

The hashing subsystem 216 is further configured to apply the cryptographic hashing techniques, such as SHA-256, to obtain hashed source addresses, hashed destination addresses and other verifiable records, ensuring efficient storage and integrity verification. By utilizing the FHE encryption and cryptographic hashing, the original Bitcoin text is transformed into privacy-preserved encrypted and hashed text. The privacy-preserved text can be validated, stored, retrieved, and used by the hybrid security gateway user 302 at any point in time while maintaining the confidentiality and integrity of the blockchain transaction data.

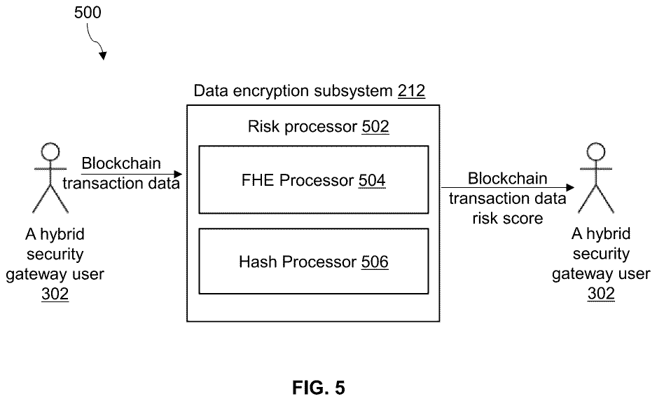

FIG. 5 illustrates an exemplary block diagram 500 of the data encryption subsystem 212 comprising a risk processor 502, in accordance with an embodiment of the present disclosure. Each of the one or more users, referred to as the hybrid security gateway user 302, provides blockchain transaction data as clear, readable text to the blockchain transaction data management system 102. The blockchain transaction data management system 102 comprises the data encryption subsystem 212, which is configured to receive the classified transaction data from the data classification subsystem 210. The data encryption subsystem 212 includes a risk processor 502, which further comprises an FHE processor 504 and a hash processor 506. The risk processor 502 is configured to assess the sensitivity and risk level of the received blockchain transaction data and generate a blockchain transaction data risk score based on predefined security parameters.

The FHE processor 504 within the risk processor 502 applies the Fully Homomorphic Encryption (FHE) technique to encrypt the classified sensitive computational transaction data, ensuring that computations can be securely performed on encrypted data without requiring decryption. This enables privacy-preserving processing of sensitive transaction attributes, such as user identities, private transaction details, and confidential contract terms. The hash processor 506, also within the risk processor 502, applies the cryptographic hashing techniques, such as SHA-256, to classified reference transaction data, including public cryptocurrency addresses, transaction identifiers, and other verifiable records. The hashing process ensures efficient storage, rapid lookup, and integrity verification while maintaining the immutability of reference data within the blockchain network.

By utilizing the FHE processor 504 and the hash processor 506, the risk processor 502 not only facilitates secure encryption and hashing but also evaluates the potential risk level associated with the transaction before storing or processing the data. This assessment ensures that transactions posing higher security risks receive additional scrutiny, enhancing overall system security. The combination of FHE encryption and cryptographic hashing converts the clear, readable transaction data into privacy-preserved encrypted and hashed text, ensuring that the hybrid security gateway user 302 can securely validate, store, retrieve, and utilize the transaction data while maintaining data confidentiality, integrity, and blockchain synchronization.

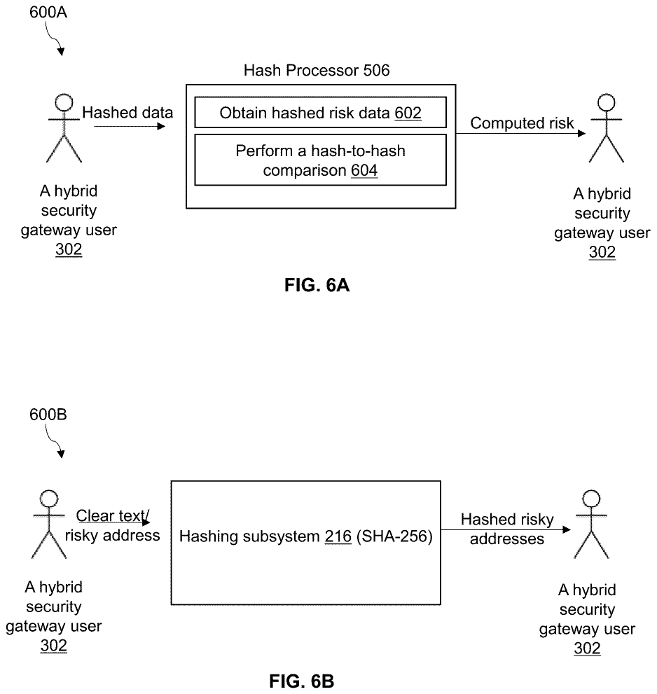

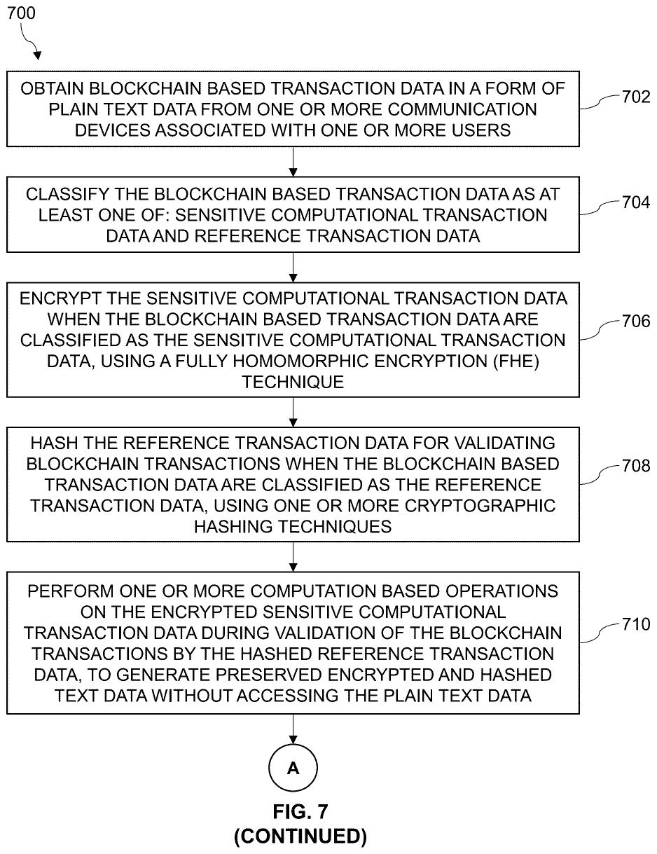

FIG. 6A illustrates an exemplary block diagram 600A of the data encryption subsystem 212 comprising a hash processor 506, in accordance with an embodiment of the present disclosure. The hash processor 506 is configured to obtain risk data, as shown in step 602. Furthermore, the hash processor 506 is configured to perform a hash-to-hash comparison, as shown in step 604, to verify the integrity and consistency of the reference transaction data (i.e., the data that does not require computations). These operations enable the hash processor 506 to generate and output the computed blockchain transaction risk score to the hybrid security gateway user 302, ensuring secure risk assessment and data integrity validation within the blockchain transaction data management system 102.

FIG. 6B illustrates an exemplary block diagram 600B of the hashing subsystem 216, in accordance with an embodiment of the present disclosure. The hashing subsystem 216, comprising the SHA-256 processor, is configured to receive clear-text transaction data or identified risky addresses and generate hashed representations of the risky addresses. The hashed risky addresses are then securely output to the hybrid security gateway user 302, ensuring data integrity, confidentiality, and risk-aware processing within the blockchain transaction data management system 102.

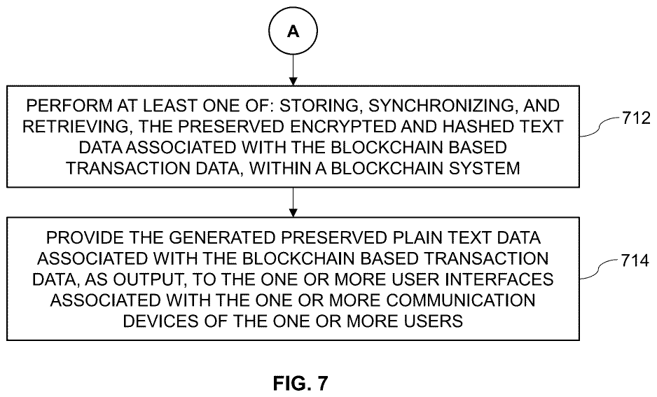

FIG. 7 is a flow diagram illustrating a blockchain transaction data management method 700 for managing blockchain based transaction data using hybrid cryptographic techniques, in accordance with an embodiment of the present disclosure.

At step 702, the blockchain based transaction data in a form of plain text data are obtained from the one or more communication devices 106 associated with the one or more users.

At step 704, the blockchain based transaction data are classified as at least one of: the sensitive computational transaction data and the reference transaction data.

At step 706, the sensitive computational transaction data are encrypted when the blockchain based transaction data are classified as the sensitive computational transaction data, using the Fully Homomorphic Encryption (FHE) technique.

At step 708, the reference transaction data are hashed for validating blockchain transactions when the blockchain based transaction data are classified as the reference transaction data, using the one or more cryptographic hashing techniques.

At step 710, the one or more computation-based operations are performed on the encrypted sensitive computational transaction data during validation of the blockchain transactions by the hashed reference transaction data, to generate the preserved encrypted and hashed text data without accessing the plain text data.

At step 712, at least one of: storing, synchronizing, and retrieving, the preserved encrypted and hashed text data associated with the blockchain based transaction data, is performed within the blockchain system.

At step 714, the generated preserved plain text data associated with the blockchain based transaction data, are provided as output, to the one or more user interfaces associated with the one or more communication devices 106 of the one or more users.

The blockchain transaction data management system 102 provides several key advantages in managing blockchain transaction data. Privacy is maintained through the use of Fully Homomorphic Encryption (FHE), ensuring that the sensitive computational transaction data remains encrypted throughout the entire computation process, preventing exposure of sensitive information during operations. Efficiency is enhanced by utilizing cryptographic hashing for the reference transaction data, which significantly reduces computational overhead for non-sensitive data, allowing for faster processing and verification.

The system 102 is also designed for scalability, supporting increased transaction volumes by optimizing resource utilization and minimizing the processing demands of sensitive and reference data. Finally, security is a cornerstone of the system 102, as it ensures the integrity and confidentiality of blockchain transactions by protecting both the sensitive computational transaction data and the reference transaction data during storage, computation, and retrieval, without exposing plaintext information at any stage.

The blockchain transaction data management system 102 and method 700 for blockchain transaction data management, is a hybrid data security gateway and is adaptable to safeguard transaction data within blockchain platforms such as Bitcoin, Ethereum, and other decentralized ledger systems, enhancing the ability to process sensitive transactions without compromising on security and performance.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system 102 either directly or through intervening I/O controllers. Network adapters may also be coupled to the system 102 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/system 102 in accordance with the embodiments herein. The system 102 herein comprises at least one processor or central processing unit (CPU). The CPUs are interconnected via the system bus 202 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the system 102. The system 102 can read the inventive instructions on the program storage devices and follow these instructions to execute the methodology of the embodiments herein.

The system 102 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A blockchain transaction data management method for managing blockchain based transaction data using hybrid cryptographic techniques, the blockchain transaction data management method comprising:
obtaining, by one or more hardware processors, the blockchain based transaction data in a form of plain text data from one or more communication devices associated with one or more users;
classifying, by the one or more hardware processors, the blockchain based transaction data as at least one of: sensitive computational transaction data and reference transaction data;
performing, by the one or more hardware processors, one or more operations comprising at least one of:
encrypting, by the one or more hardware processors, the sensitive computational transaction data when the blockchain based transaction data are classified as the sensitive computational transaction data, using a Fully Homomorphic Encryption (FHE) technique; and
hashing, by the one or more hardware processors, the reference transaction data for validating blockchain transactions when the blockchain based transaction data are classified as the reference transaction data, using one or more cryptographic hashing techniques;
performing, by the one or more hardware processors, one or more computation-based operations on the encrypted sensitive computational transaction data during validation of the blockchain transactions by the hashed reference transaction data, to generate preserved encrypted and hashed text data without accessing the plain text data;
performing, by the one or more hardware processors, at least one of: storing, synchronizing, and retrieving, the preserved encrypted and hashed text data associated with the blockchain based transaction data, within a blockchain system; and
providing, by the one or more hardware processors, the generated preserved plain text data associated with the blockchain based transaction data, as output, to the one or more user interfaces associated with the one or more communication devices of the one or more users.

2. The blockchain transaction data management method of claim 1, further comprising:
assessing, by the one or more hardware processors, security and risk level of the blockchain based transaction data based on one or more pre-defined security parameters;
generating, by the one or more hardware processors, one or more risk scores for the blockchain based transaction data based on the security and risk level of the blockchain based transaction data; and
performing, by the one or more hardware processors, one or more further operations comprising at least one of: encrypting and hashing the blockchain based transaction data based on the one or more risk scores generated for the blockchain based transaction data, to optimize security.

3. The blockchain transaction data management method of claim 1, further comprising:
analyzing, by the one or more hardware processors, at least one of: a structure and requirements of one or more application programming interfaces (APIs) within a blockchain transaction data management system; and
selecting, by the one or more hardware processors, one or more corresponding APIs based on at least one of: a nature of one or more services required and a type of date retrieval needed for blockchain based transaction data management.

4. The blockchain transaction data management method of claim 1, wherein the blockchain based transaction data comprise at least one of: transaction identities, sender and recipient details, amounts, timestamps, transaction signatures, reference metadata, transaction fees, block numbers, and consensus-related information.

5. The blockchain transaction data management method of claim 1, wherein the sensitive computational transaction data comprise at least one of: user identities, private financial details, and confidential contract terms, which are encrypted using the Fully Homomorphic Encryption (FHE) technique.

6. The blockchain transaction data management method of claim 1, wherein the reference transaction data comprise at least one of: public cryptocurrency addresses, transaction identifiers, and verifiable records, which are hashed using the cryptographic hashing techniques, wherein the cryptographic hashing techniques comprise secure hash algorithm with 256-bit fixed-length hash (SHA-256).

7. A blockchain transaction data management system for managing blockchain based transaction data using hybrid cryptographic techniques, the blockchain transaction data management system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
a data obtaining subsystem configured to obtain the blockchain based transaction data in a form of plain text data from one or more communication devices associated with one or more users;
a data classification subsystem configured to classify the blockchain based transaction data as at least one of: sensitive computational transaction data and reference transaction data;
a data encryption subsystem configured to:
encrypt the sensitive computational transaction data when the blockchain based transaction data are classified as the sensitive computational transaction data, by a FHE subsystem using a Fully Homomorphic Encryption (FHE) technique; and
hash the reference transaction data for validating blockchain transactions when the blockchain based transaction data are classified as the reference transaction data, by a hashing subsystem using one or more cryptographic hashing techniques;
a data computation subsystem configured to perform one or more computation-based operations on the encrypted sensitive computational transaction data during validation of the blockchain transactions by the hashed reference transaction data, to generate preserved encrypted and hashed text data without accessing the plain text data;
a data management subsystem configured to perform at least one of: storing, synchronizing, and retrieving, the preserved encrypted and hashed text data associated with the blockchain based transaction data, within a blockchain system; and
a data output subsystem configured to provide the generated preserved plain text data associated with the blockchain based transaction data, as output, to the one or more user interfaces associated with the one or more communication devices of the one or more users.

8. The blockchain transaction data management system of claim 7, wherein the data encryption subsystem is further configured to:
assess security and risk level of the blockchain based transaction data based on one or more pre-defined security parameters;
generate one or more risk scores for the blockchain based transaction data based on the security and risk level of the blockchain based transaction data; and
perform one or more further operations comprising at least one of: encrypting and hashing the blockchain based transaction data based on the one or more risk scores generated for the blockchain based transaction data, to optimize security.

9. The blockchain transaction data management system of claim 7, further comprising an API gateway subsystem configured to:
analyze at least one of: a structure and requirements of one or more application programming interfaces (APIs) within the blockchain transaction data management system; and
select one or more corresponding APIs based on at least one of: a nature of one or more services required and a type of date retrieval needed for blockchain based transaction data management.

10. The blockchain transaction data management system of claim 7, wherein the blockchain based transaction data comprise at least one of: transaction identities, sender and recipient details, amounts, timestamps, transaction signatures, reference metadata, transaction fees, block numbers, and consensus-related information.

11. The blockchain transaction data management system of claim 7, wherein the sensitive computational transaction data comprise at least one of: user identities, private financial details, and confidential contract terms, which are encrypted using the Fully Homomorphic Encryption (FHE) technique.

12. The blockchain transaction data management system of claim 7, wherein the reference transaction data comprise at least one of: public cryptocurrency addresses, transaction identifiers, and verifiable records, which are hashed using the cryptographic hashing techniques, wherein the cryptographic hashing techniques comprise secure hash algorithm with 256-bit fixed-length hash (SHA-256).

13. A non-transitory computer-readable storage medium having instructions stored therein that when executed by one or more hardware processors, cause the one or more hardware processors to execute operations of:
obtaining the blockchain based transaction data in a form of plain text data from one or more communication devices associated with one or more users;
classifying the blockchain based transaction data as at least one of: sensitive computational transaction data and reference transaction data;
performing one or more operations comprising at least one of:
encrypting the sensitive computational transaction data when the blockchain based transaction data are classified as the sensitive computational transaction data, using a Fully Homomorphic Encryption (FHE) technique; and
hashing the reference transaction data for validating blockchain transactions when the blockchain based transaction data are classified as the reference transaction data, using one or more cryptographic hashing techniques;
performing one or more computation-based operations on the encrypted sensitive computational transaction data during validation of the blockchain transactions by the hashed reference transaction data, to generate preserved encrypted and hashed text data without accessing the plain text data;
performing at least one of: storing, synchronizing, and retrieving, the preserved encrypted and hashed text data associated with the blockchain based transaction data, within a blockchain system; and
providing the generated preserved plain text data associated with the blockchain based transaction data, as output, to one or more user interfaces associated with the one or more communication devices of the one or more users.

14. The non-transitory computer-readable storage medium of claim 13, further comprising:
assessing security and risk level of the blockchain based transaction data based on one or more pre-defined security parameters;
generating one or more risk scores for the blockchain based transaction data based on the security and risk level of the blockchain based transaction data; and
performing one or more further operations comprising at least one of: encrypting and hashing the blockchain based transaction data based on the one or more risk scores generated for the blockchain based transaction data, to optimize security.

15. The non-transitory computer-readable storage medium of claim 13, further comprising:
analyzing at least one of: a structure and requirements of one or more application programming interfaces (APIs) within the blockchain transaction data management system; and
selecting one or more corresponding APIs based on at least one of: a nature of one or more services required and a type of date retrieval needed for blockchain based transaction data management.

16. The non-transitory computer-readable storage medium of claim 13, wherein the blockchain based transaction data comprise at least one of: transaction identities, sender and recipient details, amounts, timestamps, transaction signatures, reference metadata, transaction fees, block numbers, and consensus-related information.

17. The non-transitory computer-readable storage medium of claim 13, wherein the sensitive computational transaction data comprise at least one of: user identities, private financial details, and confidential contract terms, which are encrypted using the Fully Homomorphic Encryption (FHE) technique.

18. The non-transitory computer-readable storage medium of claim 13, wherein the reference transaction data comprise at least one of: public cryptocurrency addresses, transaction identifiers, and verifiable records, which are hashed using the cryptographic hashing techniques, wherein the cryptographic hashing techniques comprise secure hash algorithm with 256-bit fixed-length hash (SHA-256).
